(19) United States
(12) Patent Application Publication
(10) Pub. No.: US 2007/0266953 A1
(43) Pub. Date: Nov. 22, 2007

(54) Insert for a Cat Lavatory

(76) Inventors: Wolfram Zoller, Kirchlinteln-Hohenaverbergen (DE); Jurgen Hommola, Minden (DE); Rolf Hornig, Kirchlinteln/Luttum (DE); Dietmar Lange, Vallendar (DE)

Correspondence Address: FULBRIGHT & JAWORSKI, LLP, 1301 MCKINNEY, SUITE 5100, HOUSTON, TX, 77010-3095, US

(21) Appl. No.: 10/597,461

(22) PCT Filed: Dec. 23, 2004
(86) PCT No.: PCT/EP04/14651

§ 371 Date: Jun. 1, 2007

(51) Int. Cl. A01K 29/00

(52) U.S. Cl. 119/169; 119/165

(57) ABSTRACT

The present invention relates to an insert which can be placed in a lower part of a cat lavatory and is replaceable, wherein the blank of the insert is substantially rectangular, the corners of the insert being sloped.

### CROSS-REFERENCE TO RELATED APPLICATIONS

This application is a national stage application of PCT/EP2004/014651 filed Dec. 23, 2004 claiming priority to DE 102004010733.5 filed Mar. 5, 2004.

### TECHNICAL FIELD

The present invention relates to an insert for a cat lavatory.

### BACKGROUND OF THE INVENTION

Inserts for cat lavatories are known generally from the state of the art. WO 02/071837 A1, for example, describes a cat lavatory with a lower part and an insert of the generic type which contains an absorbent material and can be placed in the lower part, the insert comprising an insert of non-woven material. Using an insert of this kind for a cat lavatory, which comprises an insert of non-woven material, the quantity of litter material required can be reduced considerably, while at the same time, as can be seen clearly from the figures of WO 02/071837 A1, soiling of the walls of the cat lavatory can be avoided, since the insert is designed such that an edge portion thereof can be folded out and over the upper peripheral rim of the lower part. The insert preferably takes the form of a pouch.

With the inserts for cat lavatories known from the state of the art, however, it is problematic to place them in the cat lavatory, since the inserts are substantially rectangular in shape, which inevitably leads, upon insertion, to the formation of kinks in the corners of the cat lavatory, when the insert is to be folded over the peripheral rim of the lower part. A rectangular blank for the insert is a problem, in particular because there is no standardized size and shape for cat lavatories. Arranging the inserts known from the state of the art in a cat lavatory is therefore difficult, since room has to be found somehow or other in the lower part for the folded parts. Furthermore, a cat using a cat lavatory with an insert of this kind can easily catch its paws in the folded parts in the corner region, as a result of which the insert can be damaged and, finally, the cat lavatory into which the insert has been placed can be soiled.

It is the object of the present invention to improve the insert of the generic type in such a way that the disadvantages of the prior art are overcome, and especially to provide an insert which can be placed in a cat lavatory with fewer problems and, in addition, which cannot be easily damaged by a cat.

### BRIEF SUMMARY OF THE INVENTION

This object is achieved in accordance with the invention in that the blank of the insert is substantially rectangular, the corners of the insert being sloped.

It is particularly preferable for the insert to be a pouch.

It is also preferable for the blank of the insert to be substantially rectangular or square.

One embodiment of the invention provide for each slope, beginning at the corresponding corner of the insert, to account for about ⅕ of the length of the associated transverse side and about 2/7 of the length of the associated longitudinal side of the insert.

It can advantageously be provided for the insert to be capable of being opened in such a way that its edge portion which is at the top after it has been inserted into the lower part is capable of being folded outwards and over the upper peripheral rim of the lower part and of being folded together after the end of its period of use, so that it can be re-sealed.

It is particularly advantageous for the insert to comprise an insert of non-woven material.

In this context, it is provided for the insert of non-woven material to comprise a highly absorbent, odour-inhibiting and scratch-resistant material.

In addition, it can particularly preferably be provided for the insert of non-woven material to be of a shape with external dimensions which correspond substantially to the internal dimensions of the lower part.

It is advantageously provided for a layer of litter material to be disposed on the insert of non-woven material.

It can also be provided for the insert to be vacuum-packed before use.

A further embodiment of the invention is characterised by at least one closure means, preferably an adhesive strip, a tape or a clip, for re-sealing the insert after use.

The insert of the invention can be placed in a cat lavatory with a lower part.

The invention is thus based on the surprising finding that, thanks to the sloping at the corners of the insert, when the latter is placed in a cat lavatory, the formation of kinks in the comers of the cat lavatory is substantially avoided. First of all, this simplifies the arrangement of the insert itself, and at the same it also ensured that cats cannot stick their paws behind the kinks when using the cat lavatory. In this way, the insert of the invention prevents the insert from being damaged by the cat and thus ensures that the cat lavatory cannot be easily soiled. The insert of the invention is adaptable for cat lavatories of all sizes and shapes.

### BRIEF DESCRIPTION OF THE DRAWINGS

Further features and advantages of the invention will become apparent from the following detailed description of a preferred embodiment of the invention with reference to the attached drawings. In which:

FIG. 1 shows a schematic view of a first step in placing the insert of the invention in a lower part of a cat lavatory;

FIGS. 2 to 7 show further steps in placing the insert of the invention into the lower part or removing it from said lower part; and

FIGS. 8a and 8b show cross-sections through two embodiments of a cat lavatory in accordance with the invention.

### DETAILED DESCRIPTION OF THE INVENTION

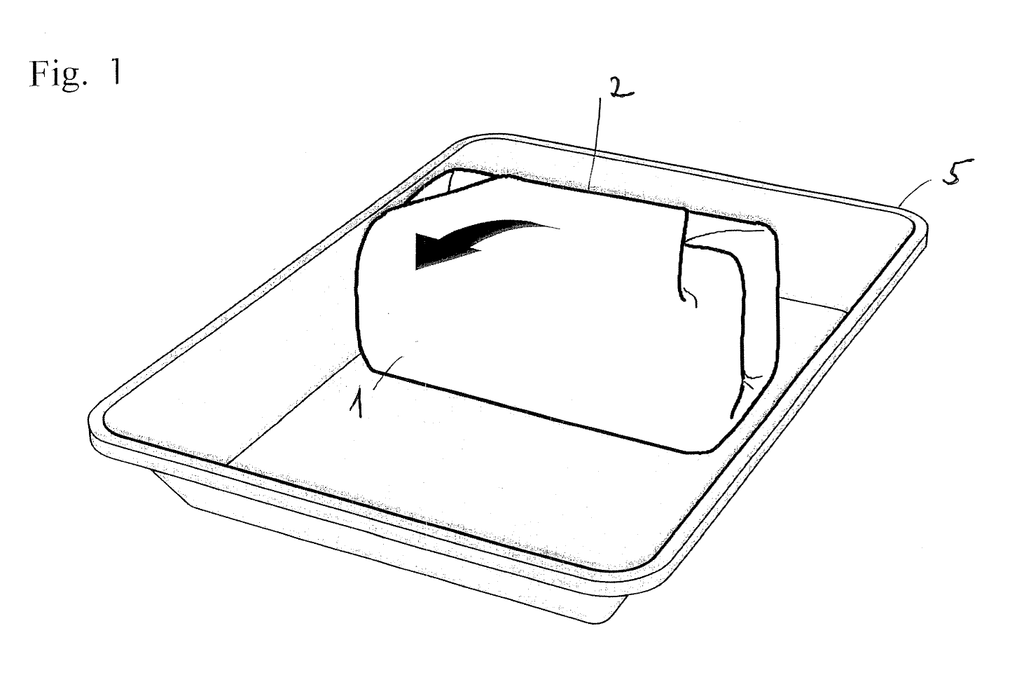

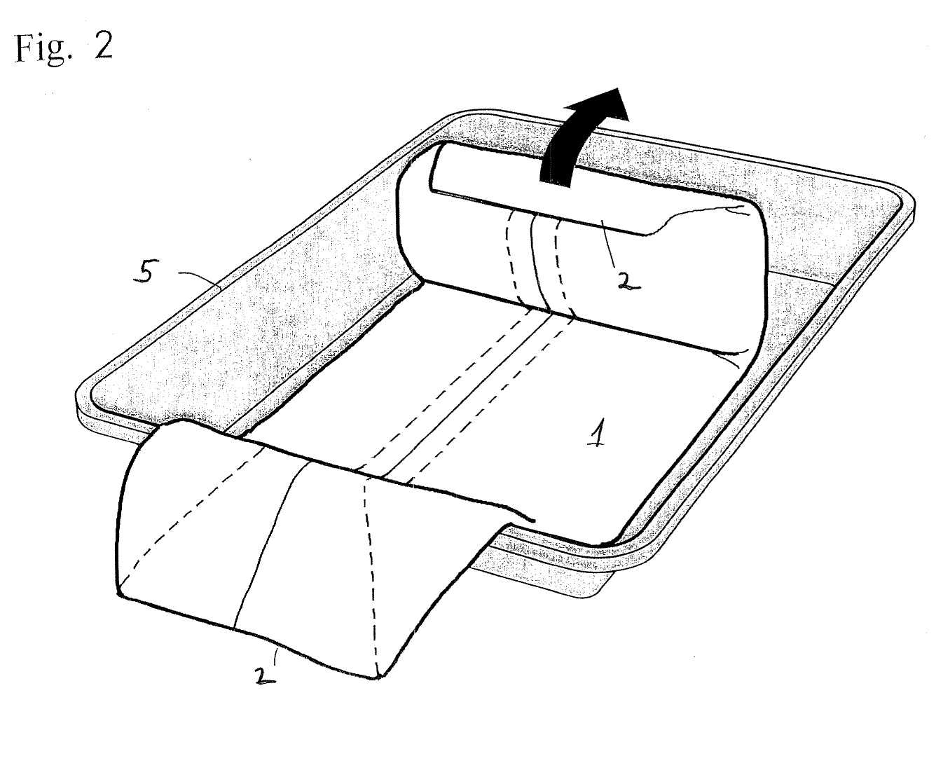

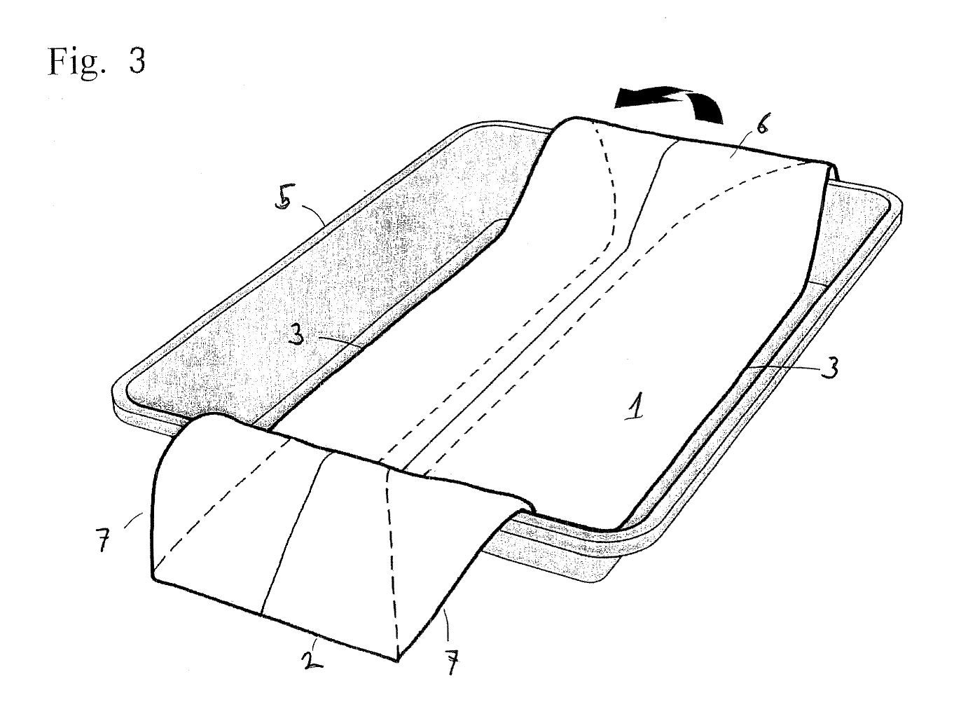

FIG. 1 shows an insert 1 of the invention, which is placed, in a rolled-up state, in a lower part 5 of a cat lavatory of the invention. In order to use the insert 1, first of all a transverse side 2 of the insert 1 is unrolled in the direction indicated by the arrow in FIG. 1, so that it projects over the upper peripheral rim of the lower part 5, as shown in FIG. 2. The other transverse side 2 of the insert 1 can likewise be unrolled in this way, in the direction of the arrow shown in FIG. 2, so that an arrangement of the insert 1 results which is shown in FIG. 3. As can be seen from FIG. 3, the insert 1 of the invention has a substantially rectangular blank with transverse sides 2 and longitudinal sides 3. In insert 1, however, all four corners 7 of the blank are sloped in accordance with the invention. The sloping can preferably be provided such that the slope on the transverse sides 2, beginning at the corresponding corners 7 of the blank, account for about ⅕ of the total length of the transverse sides 2, while the slope on the longitudinal sides 3 account for about 2/7 of the total length of the longitudinal sides 3. This kind of slope leads to the shape of insert 1 shown in FIG. 3.

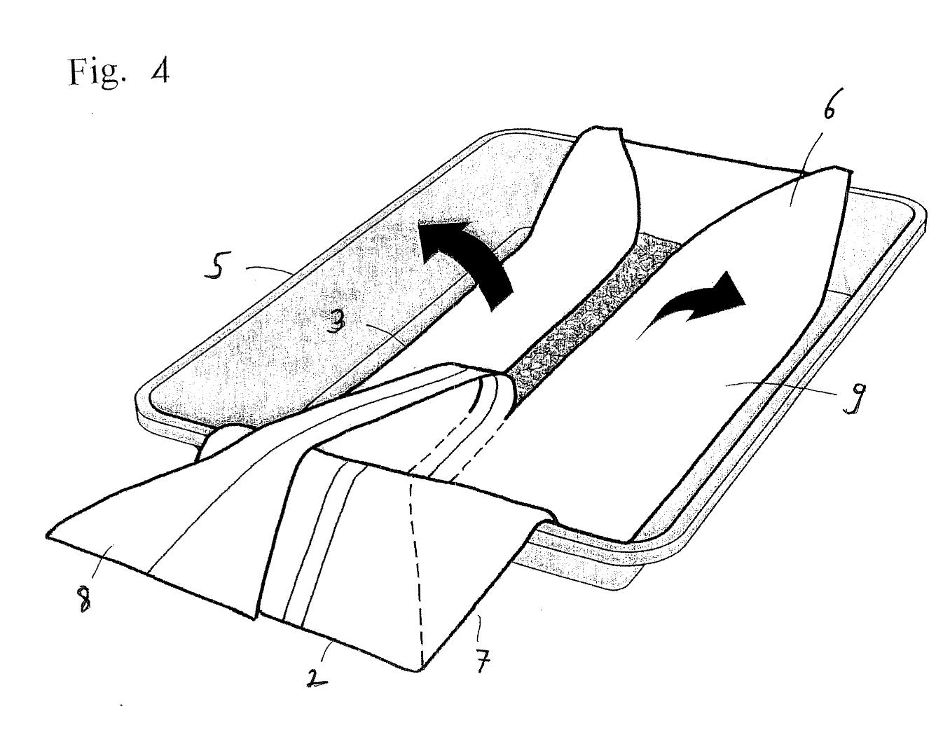

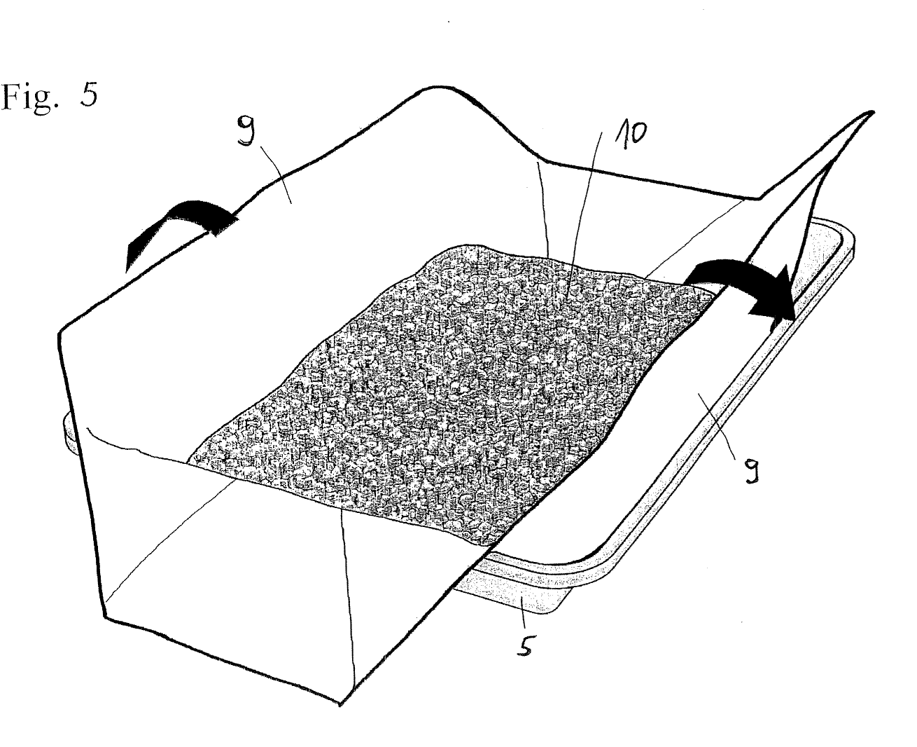

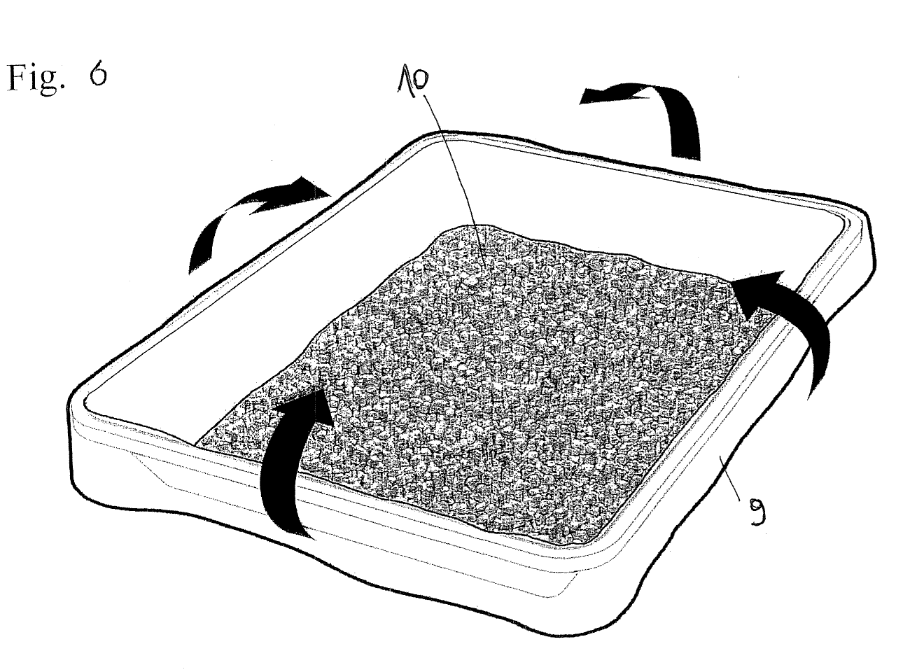

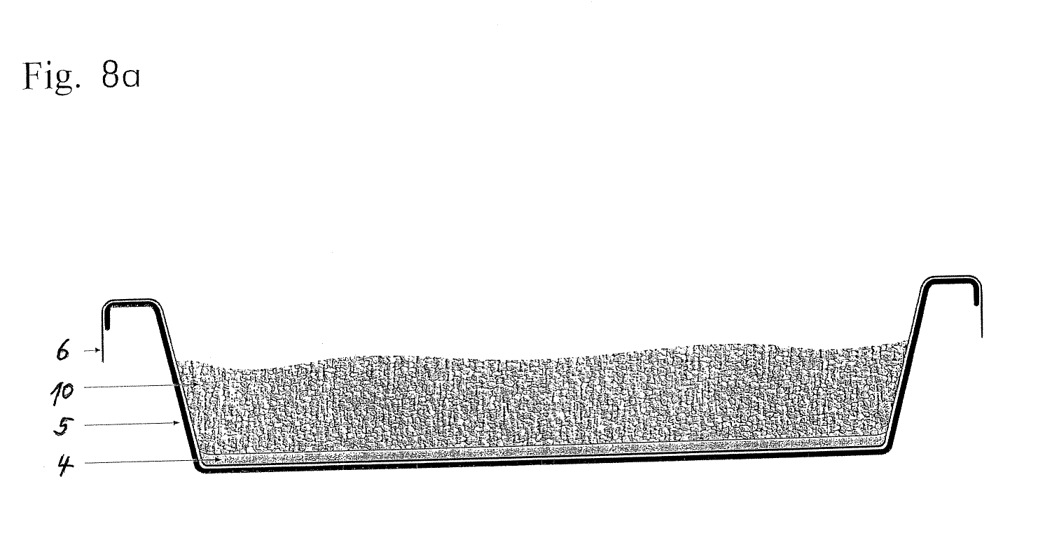

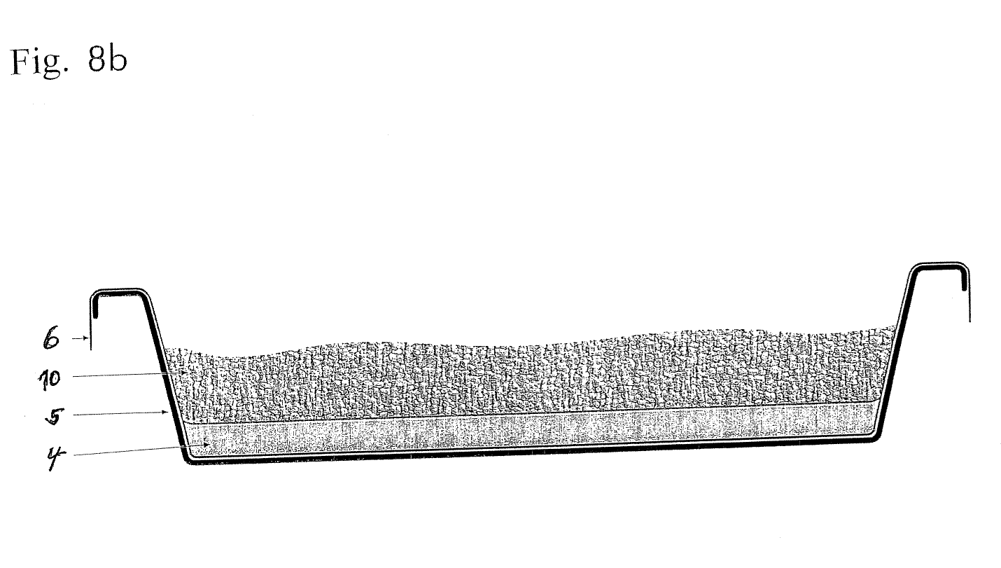

It goes without saying that the shape and dimensions of the slopes can be varied and adapted to a specific cat lavatory in a targeted manner. It is particularly preferred in accordance with the invention that the insert should be a pouch 6, which is provided in a rolled-up state and can then be unrolled into the lower part 5, as illustrated in FIGS. 1 to 3. Other insert shapes will nevertheless be conceivable for a man skilled in the art, such as a folding package, as disclosed in WO 02/071837 A1. The pouch 6 can, as is shown in FIG. 4, be opened simply, in that, for example, a tear-off seam or a tear-off strip 8 is torn off or removed. According to FIGS. 5 and 6, an upper edge portion 9 of the pouch and the region with the sloping corners 7 can be simply folded out and over the upper peripheral rim of the lower part 5, so that all the interior surfaces of the lower part 5 are lined with pouch material. As can be seen particularly well from FIG. 6, it is possible to provide, inside the blank of insert 1, preferably in a region without slopes, a layer of litter material 10, beneath which can be disposed an insert of non-woven material 4, which is shown in FIGS. 8a and 8b.

The possible specific designs of the insert of non-woven material 4 and of the layer of litter material 10 will readily occur to a man skilled in the art, so that this will not be described in more detail here. It should merely be emphasized that the insert of non-woven material 4 and the layer of litter material 10 have external dimensions which correspond substantially to the internal dimensions of a lower part of a cat lavatory.

The pouch 6 is preferably placed in the lower part 5 of a cat lavatory in such a way that the insert of non-woven material 4 or the layer of litter material 10 cover the floor portion of the lower part 5 substantially completely. The areas of the pouch 6 in which substantially no insert of non-woven material 4 or layer of litter material 10 is present, but which nevertheless have sloping corners 7, extend outwardly and over the upper peripheral rim of the lower part 5.

It can be seen from FIG. 6 in particular that, after the pouch 6 has been introduced, substantially no kinks are present in the corned portions of the lower part 5, which leads to the benefits of the insert of the invention 1 as described above. The pouch 6 can be secured at the lower part 5 by a wide range of possible means, such as by attaching adhesive strips or by placing a top part of the cat lavatory on the lower part 5, as a result of which the pouch 6 is arranged firmly on the cat lavatory.

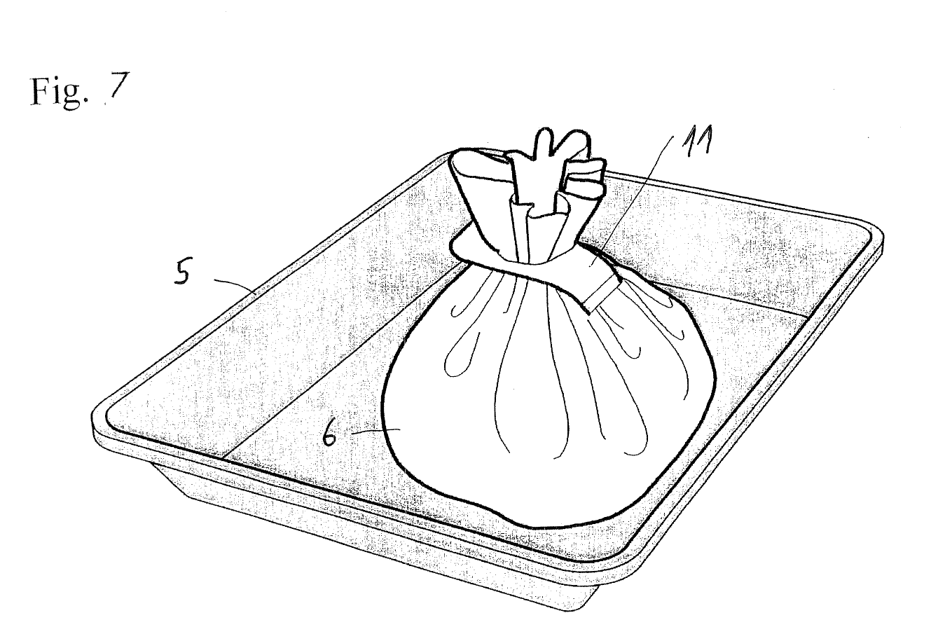

After the pouch 6 has been used, it can, as indicated by the arrows in FIG. 6, be folded together and sealed by a closure means, and then disposed of, as is illustrated in FIG. 7. The pouch 6 shown in FIG. 7 is sealed with a clip 11.

FIGS. 8a and 8b show a cross-section through a cat lavatory of the invention, a pouch 6 having been placed in the lower part 5 of the cat lavatory. When the edges of the pouch 6 are folded over the upper peripheral rim of the lower part 5 and the pouch 6 is opened in this way, the layer of litter material 10 and the insert of non-woven material 4 beneath it are revealed, so that the cat lavatory is ready for use. FIG. 8b shows an embodiment the cat lavatory in which the insert of non-woven material 4 is thicker and the layer of litter material 10 is thinner than shown in FIG. 8a.

The insert of the invention is not limited to use in a cat lavatory, but can be used for various animals.

The features of the invention disclosed in the above description, in the drawings and in the claims can be essential to implementing the invention in its various embodiments both individually and in any combination.

1. An insert which can be placed in a lower part of a cat lavatory and is replaceable, comprising:
an insert having a blank that is substantially rectangular and having corners, the corners of the insert being sloped.

2. The insert as claimed in claim 1, wherein the insert is a pouch.

3. The insert as claimed in claim 1, wherein the blank of the insert is substantially rectangular or square.

4. The insert as claimed in claim 1, wherein each slope, beginning at the corresponding corner of the insert, accounts for about ⅕ the length of an associated transverse side and for about 2/7 the length of an associated longitudinal side of the insert.

5. The insert as claimed in claim 1, wherein the insert is capable of being opened in such a way that its edge portion, which is at the top after it has been inserted into the lower part of the cat lavatory, is capable of being folded outwards and over an upper peripheral rim of the lower part and of being folded together after the end of its period of use, so that it can be re-sealed.

6. The insert as claimed in claim 1, wherein the insert is formed from non-woven material.

7. The insert as claimed in claim 6, wherein the insert of non-woven material comprises a highly absorbent, odour-inhibiting and scratch-resistant material.

8. The insert as claimed in claim 6, wherein the insert of non-woven material has a shape with external dimensions which correspond substantially to the internal dimensions of the lower part of the cat lavatory.

9. The insert as claimed in claim 6, wherein a layer of litter material is disposed on the insert of non-woven material.

10. The insert as claimed in claim 1, wherein the insert is vacuum-packed before use.

11. The insert as claimed in claim 1, wherein at least a closure means, is provided, for resealing the insert after use.

12. Cat lavatory with a lower part, comprising:
an insert having a blank that is substantially rectangular and having corners, the corners of the insert being sloped;
wherein the insert is placed in the lower part of the cat lavatory.

13. The insert as claimed in claim 11, wherein the closure means is selected form a group consisting of an adhesive strip, a tape and a clip.
